(19) United States
(12) Patent Application Publication
(10) Pub. No.: US 2012/0164523 A1
(43) Pub. Date: Jun. 28, 2012

(54) LITHIUM ION SECONDARY BATTERY

(75) Inventors: Masanori YOSHIKAWA, Hitachinaka (JP); Akihiko Noie, Hitachinaka (JP)

(73) Assignee: Hitachi, Ltd.

(21) Appl. No.: 13/330,722

(22) Filed: Dec. 20, 2011

(30) Foreign Application Priority Data
Dec. 28, 2010 (JP) 2010-291551

(51) Int. Cl. H01M 10/0561

(52) U.S. Cl. 429/188

(57) ABSTRACT

A lithium ion secondary battery with high reliability and high safety is provided. The lithium ion secondary battery includes a positive electrode for occluding and releasing lithium ions, a negative electrode for occluding and releasing lithium ions, a non-aqueous liquid electrolyte containing a lithium salt, and a separator disposed between the positive electrode and the negative electrode. The positive electrode includes particles of polymethyl methacrylate. Preferably, particles of positive electrode active material in the positive electrode are covered with the particles of polymethyl methacrylate.

### CLAIM OF PRIORITY

The present application claims priority from Japanese Patent Application JP 2010-291551 filed on Dec. 28, 2010, the content of which is hereby incorporated by reference into this application.

### FIELD OF THE INVENTION

The present invention relates to a lithium ion secondary battery.

### BACKGROUND OF THE INVENTION

In order to put a battery into practical use, improvement in the reliability and safety, as well as improvement in performance, are important for the battery. Japanese Patent Application Publication No. 9-35705 discloses a technique for a battery including a polymer solid electrolyte. In Japanese Patent Application Publication No. 9-35705, the performances of a battery including the polymer solid electrolyte, in particular, the capacity and life cycle of the battery, are improved by covering the surfaces of particles of the positive electrode active material with particles of conductive agent. In addition, a technique is disclosed in which the safety of a battery is improved by adding an additive to a liquid electrolyte as a technique for enhancing the safety of a battery by improving a liquid electrolyte.

Japanese patent Application Publication No. 6-52889 discloses a technique in which, even if the relief valve of a battery is opened due to an abnormal increase in the temperature of a battery and accordingly air enters the interior of the battery from the opened relief valve, a contact between the entered air and a negative electrode is hampered by the polymethacrylate added to a liquid electrolyte, a rapid reaction being avoided between the entered air and a negative electrode and improving the safety of the battery.

If an additive is added to a liquid electrolyte, the resistance of the liquid electrolyte increases, raising a concern about a decrease in output of the battery with the increase of the resistance. That is, adding an additive to a liquid electrolyte may make it difficult to secure a high output, which is one of the characteristics important for the lithium ion secondary batteries for vehicles.

In view of these situations, an object of the present invention is to provide a lithium ion secondary battery with high reliability and high safety, which can be applied to environmentally compatible vehicles, such as next-generation clean energy vehicles.

### SUMMARY OF THE INVENTION

As a result of intensive study by the present inventors, it has been found that the aforementioned problem can be solved by including particles of polymethyl methacrylate in a positive electrode, and that a lithium ion secondary battery with high reliability and high safety can be provided, which is applicable to environmentally compatible vehicles, such as next-generation clean energy vehicles. It is particularly preferable that particles of the positive electrode active material in the positive electrode are covered with particles of polymethyl methacrylate. It is also preferable that the content of polymethyl methacrylate is 5 weight percent or less in the positive electrode active material.

The present invention provides a lithium ion secondary battery with high reliability, high safety, high capacity, and long life, which can be preferably applied to environmentally compatible vehicles, such as next-generation clean energy vehicles.

### BRIEF DESCRIPTION OF THE. DRAWINGS

FIG. 1 is a side cross sectional view of a cylindrical lithium ion secondary battery; and

FIG. 2 is a conceptual diagram of a particle of the positive electrode active material covered with particles of polymethyl methacrylate.

### DETAILED DESCRIPTION OF THE PREFERRED EMBODIMENTS

From the viewpoints of reducing environmental loads such as emission reduction in carbon dioxide and of reducing energy dependence on petroleum, it is desired that next-generation clean energy vehicles, such as electric vehicles, plug-in hybrid vehicles, and fuel cell vehicles, are put into practical use. A lithium ion secondary battery is lightweight and compact and has a high specific energy and a high specific output power. Therefore, the expectation for the lithium ion secondary battery has been mounting in recent years to be put into practical use as power sources for such next-generation clean energy vehicles. It is more important to further improve reliability and safety of the battery in order to meet the expectation and put the battery into practical use, needless to say that high performance of the battery is needed.

In view of these situations, various techniques have been studied with respect to improvement in performance and safety of batteries by improving a structure of batteries and improving materials of batteries, such as material of positive electrode, material of negative electrode, liquid electrolyte, and separator. In particular, safety of a lithium ion secondary battery has been studied from various viewpoints, such as materials and structures of the battery.

With respect to materials of the battery, techniques are proposed, and are actively studied and developed with respect to improvement in performance of the battery by improving materials of positive and negative electrodes, and with respect to improvement in safety of the battery by making a liquid electrolyte fire-retardant or fireproof or by applying a polymer solid electrolyte. For example, various factors can be considered as a cause of heat generation or ignition of a battery. Among the factors, heat generation of a positive electrode is considered to be a major factor for ignition of the battery. Because a positive electrode is unstable in an overcharge region, an exothermic reaction is generated between the positive electrode and a liquid electrolyte, thereby causing an increase in temperature of the battery. If the temperature is further increased to reach hundreds of degrees Celsius, a thermal decomposition reaction of the positive electrode is caused. Then, the battery enters a so-called thermal runaway region, increasing the possibilities of an ignition and a damage of a battery can.

Accordingly, with respect to the materials of a battery, improving the thermal stability of material of a positive electrode and making a liquid electrolyte fire-retardant or fire-proof are devised. In addition, the ionic conductivity of a fire-retardant or fire-proof liquid electrolyte or a polymer solid electrolyte is lower than that of a currently used non-aqueous liquid electrolyte, causing the concern that an output of the battery may be decreased. Accordingly, such a liquid electrolyte and a polymer solid electrolyte have not been applied to the batteries mounted in vehicles such as next-generation clean energy vehicles.

The present invention relates to a lithium ion secondary battery including a positive electrode for occluding and releasing lithium ions, a negative electrode for occluding and releasing lithium ions, a non-aqueous liquid electrolyte containing a lithium salt, and a separator disposed between the positive electrode and the negative electrode. In order to avoid an increase in the temperature of a battery, it is important to suppress an exothermic reaction between a positive electrode and a liquid electrolyte, which is considered to be a factor for heat generation of the battery. Our various studies obtained a result that a lithium ion secondary battery with high reliability and high safety can be provided by using a positive electrode including particles of polymethyl methacrylate. Accordingly, the invention particularly relates to a lithium ion secondary battery in which the positive electrode includes particles of polymethyl methacrylate.

The particles of polymethyl methacrylate used in the present invention are cross-linked together, and have a property of being insoluble in the organic solvent in a liquid electrolyte. If a polymer, such as polymethyl methacrylate, is dissolved in a liquid electrolyte, the viscosity of the liquid electrolyte is increased, causing the concern that an output of the battery may be decreased with an increase in resistance of the liquid electrolyte. However, the present invention does not cause such a concern.

Further, polymethyl methacrylate has a property of absorbing a liquid electrolyte at a temperature higher than or equal to one hundred and tens of degrees Celsius. Accordingly, when a battery is in an abnormal state (the temperature is 100° C. or higher), polymethyl methacrylate absorbs a liquid electrolyte, depleting the liquid electrolyte around the positive electrolyte, and making it possible to avoid an exothermic reaction between the positive electrode and the liquid electrolyte to suppress an increase in the temperature of the battery.

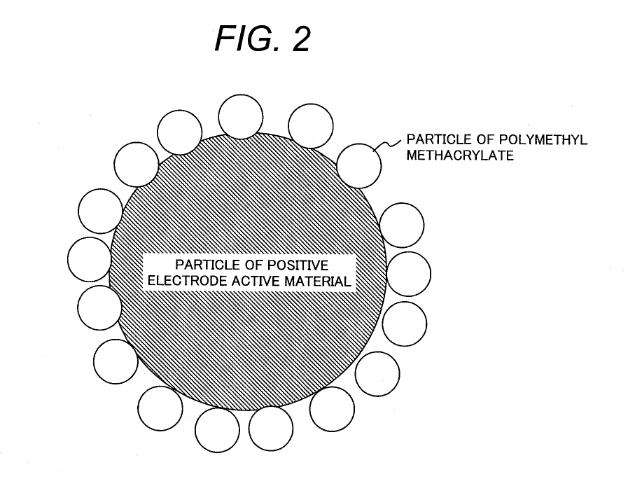

In the present invention, heat generation of a battery in an abnormal state can be suppressed by including particles of polymethylmethacrylate in the positive electrode. Examples of a method for including particles of polymethyl methacrylate in the positive electrode include a method for covering the surfaces of particles of the positive electrode active material with particles of polymethyl methacrylate (FIG. 2), and a method for mixing polymethyl methacrylate with the positive electrode active material. Any method of the above can achieve the advantage of the present invention.

When mixing polymethyl methacrylate with the positive electrode active material, it is preferable that particles of polymethyl methacrylate are disposed in gaps between particles of the positive electrode active material. To make this configuration possible, it is preferable that the size of the particles of polymethyl methacrylate is ⅕ or smaller than that of the particles of the positive electrode active material.

When covering the surfaces of particles of the positive electrode active material with particles of polymethyl methacrylate, it is preferable that the size of the particles of polymethyl methacrylate is 1/10 or smaller than that of the particles of the positive electrode active material. In particular, when the surfaces of the particles of the positive electrode active material are directly covered with the particles of polymethyl methacrylate, an advantage of absorbing the liquid electrolyte around the surfaces of the particles of the positive electrode active material can be sufficiently exerted.

If the content of the particles of polymethyl methacrylate is made large, the safety of the battery is improved. However, if the particles of polymethyl methacrylate, which are insulators, are included in a large amount, the resistance of the battery is increased and an output of the battery is decreased. In view of these conditions, it is preferable that the content of polymethyl methacrylate is 5 weight percent or less in the positive electrode active material.

The positive electrode is formed by applying a positive electrode mixture to both of the surfaces of an aluminum foil and then by drying and pressing the aluminum foil. The positive electrode mixture includes a positive electrode active material, polymethyl methacrylate, a conductive agent, and a binder. Alternatively, the positive electrode can be formed by covering the surfaces of the particles of the positive electrode active material with the particles of polymethyl methacrylate, then by applying a positive electrode mixture to both of the surfaces of an aluminum foil and then by drying and pressing the aluminum foil, the positive electrode mixture including the positive electrode active material with polymethyl methacrylate, a conductive agent, and a binder. In the formed positive electrode, the particles of polymethyl methacrylate exist between the particles of the positive electrode active material. The particles of polymethyl methacrylate are in contact with surfaces of the particles of the positive electrode active material.

Examples of the positive electrode active material include a substance represented by a chemical formula of LiMO₂ (wherein M is at least one transition metal) and spinel manganese. A substance can also be used for the positive electrode active material, in which part of Mn, Ni or Co in the positive electrode active material, such as lithium manganese oxide, lithium nickel oxide, or lithium cobalt oxide, has been substituted with one or more transition metals. Further, a substance can also be used for the positive electrode active material, in which part of the transition metals in the positive electrode active material has been substituted with a metal element, such as Mg or Al.

The conductive agent is not particularly limited, as far as a publicly-known conductive agent is used, such as a carbon conductive agent selected from the group consisting of, for example, graphite, acetylene black, carbon black, and carbon fiber.

The binder is not particularly limited, as far as a publicly-known binder is used, such as polyvinylidene fluoride or fluoro-rubber. A preferred binder in the present invention is polyvinylidene fluoride, for example.

A solvent to be used appropriately can be selected from various publicly-known solvents, and an organic solvent, such as N-methyl-2-pyrrolidone, is preferably used, for example.

The mixing ratio of the positive electrode active material, polymethyl methacrylate, conductive agent, and binder in the positive electrode mixture is not particularly limited, preferably being 1:0.005-0.05:0.05-0.20:0.02-0.10 by weight ratio when the weight of the positive electrode active material is indicated by 1, for example.

If the amount of added polymethyl methacrylate is too large, the resistance of the positive electrode (the resistance of the battery) may be increased, while the amount of added polymethyl methacrylate is too small, the advantage of absorbing the liquid electrolyte is small. Accordingly, the amount of added polymethyl methacrylate is preferably within a range of 0.5 to 5 weight percent in the positive electrode active material.

The negative electrode is formed by applying a negative electrode mixture including a negative electrode active material and a binder to both of the surfaces of a copper foil and then by drying and pressing the copper foil. A substance preferred for the negative electrode active material is a carbon material, such as graphite or amorphous carbon.

The binder is not particularly limited and, for example, the same material as of the positive electrode can be used. A material preferred as the binder is polyvinylidene fluoride, for example.

The preferred solvent is, for example, an organic solvent, such as N-methyl-2-pyrrolidone.

In the negative electrode mixture, the mixing ratio of the negative electrode active material and the binder is not particularly limited. One example of the mixing ratio is 1:0.05-0.20 by weight ratio when the weight of the negative electrode active material is indicated by 1.

The non-aqueous liquid electrolyte in the present invention is not particularly limited and a publicly-known non-aqueous liquid electrolyte can be used. Examples of the non-aqueous solvent include, for example, propylene carbonate, ethylene carbonate, butylene carbonate, vinylene carbonate, dimethyl carbonate, diethyl carbonate, methyl-ethyl carbonate, tetrahydrofran, 1,2-ditethoxyethane. The non-aqueous liquid electrolyte can be prepared by dissolving one or more lithium salts selected from the group consisting of, for example, LiPF₆, LiBF₄, and LiClO₄ in one or more of the aforementioned non-aqueous solvents.

The shape of the lithium ion secondary battery is not particularly limited, and examples of the shape include a spirally-wound type and a stacked type.

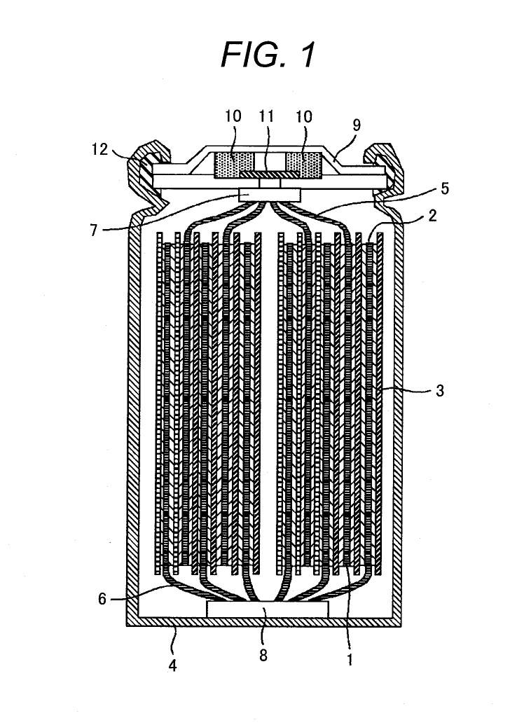

FIG. 1 illustrates an example of a cylindrical lithium ion secondary battery. A positive electrode 1 for occluding and releasing lithium ions and a negative electrode 2 for occluding and releasing lithium ions are disposed sandwiching a separator 3 in the lithium ion secondary battery. The lithium ion secondary battery includes the positive electrode 1 made by applying the aforementioned positive electrode mixture to both of the surfaces of an aluminum foil; the negative electrode 2 made by applying the aforementioned negative electrode mixture to both of the surfaces of a copper foil; the separator 3 disposed between the positive electrode 1 and the negative electrode 2; positive electrode collecting lead pieces 5 for connecting the positive electrode 1 and a positive electrode collecting lead portion 7; negative electrode collecting lead pieces 6 for connecting the negative electrode 2 and a negative electrode collecting lead portion 8; a battery can 4, the bottom of which is connected to the negative electrode collecting lead portion 8; a battery cover 9 caulked and fixed to the open end of the battery can 4 via a gasket 12; a positive electrode terminal portion 10 in contact with the back surface of the battery cover 9; and a safety valve 11 sandwiched between a part and another part of the positive electrode terminal portion 10.

The positive electrode 1 and the negative electrode 2 are wound holding the separator 3 between them and arranged inside the battery can 4 as an electrode group. The space formed by the battery can 4 and the battery cover 9 is filled with a non-aqueous liquid electrolyte (not illustrated in FIG. 1) containing lithium salts.

For example, a cylindrical lithium ion secondary battery can be produced as follows.

A positive electrode slurry is obtained by adding polymethyl methacrylate, a conductive agent such as graphite, and a binder such as polyvinylidene fluoride dissolved in a solvent such as N-methyl-2-pyrrolidone to the positive electrode active material by the weight ratio of the aforementioned one and then by kneading them, or obtained by adding the conductive agent and the binder to the positive electrode active material covered with polymethyl methacrylate by the weight ratio of the aforementioned one, and then by kneading them. Subsequently, the slurry is applied to both of the surfaces of an aluminum metallic foil that is a collector. Thereafter, the aluminum metallic foil is dried and pressed to produce the positive electrode.

Subsequently, a negative electrode slurry is obtained, for example, by adding polyvinylidene fluoride dissolved in N-methyl-2-pyrrolidone as a binder to the negative electrode active material by the weight ratio of the aforementioned one, and then by kneading them. Subsequently, the slurry is applied to both of the surfaces of a copper foil that is a collector, and then the copper foil is dried and pressed to produce the negative electrode.

The non-aqueous liquid electrolyte is produced by dissolving LiPF₆, etc., in a non-aqueous mixed solvent, such as propylene carbonate, ethylene carbonate, dimethyl carbonate, and diethyl carbonate.

The separator formed of a porous polymer resin film made of polyethylene, polypropylene, or the like, is disposed between the obtained positive electrode and negative electrode.

The positive electrode, the negative electrode, and the separator are wound before they are inserted in the battery can formed of stainless steel or aluminum. After the lead pieces of the electrodes are connected to the battery can or the battery cover, the non-aqueous liquid electrolyte is poured into the battery can and the open end of the battery can is sealed, thereby obtaining the lithium ion secondary battery.

Examples of the applications of the lithium ion secondary battery include auxiliary powers for environmentally compatible vehicles, such as next-generation clean energy vehicles including fuel cell vehicles and plug-in hybrid vehicles as stated above, and power sources used in a field in which high outputs are needed. The lithium ion secondary battery can be widely applied to power sources for electrical power tools in which high-load characteristics, high capacity, and high output are needed, and further applied to mobile devices.

### EXAMPLES

Hereinafter, examples of the present invention will be specifically described, however, these examples does not limit the scope of the invention.

### Example 1

As a positive electrode active material, LiCoO₂ having an average particle size of 15 μm was used. As polymethyl methacrylate, particles of polymethyl methacrylate having an average size of 1 μm were used. N-methyl-2-pyrrolidone was added to a mixture of the positive electrode active material, polymethyl methacrylate, graphite as a conductive agent, and polyvinylidene fluoride as a binder, the weight ratio of the positive electrode active material, polymethyl methacrylate, graphite, and polyvinylidene fluoride being 83:2:10:5. The mixture was kneaded for 30 minutes by using a kneader to obtain a positive electrode mixture. The obtained positive electrode mixture was applied to both of the surfaces of an aluminum foil having a thickness of 30 μm that was a collector.

As a negative electrode active material, a graphite material was used. As a binder, polyvinylidene fluoride was used. The negative electrode active material and the binder were mixed by the weight ratio of 90:10, and the mixture was kneaded to obtain a negative electrode mixture. The obtained negative electrode mixture was applied to both of the surfaces of a copper foil having a thickness of 20 μm.

Each of the produced positive and negative electrodes was rolled and formed with a pressing machine and then dried in vacuum at 150° C. for 5 hours. The positive electrode 1 and the negative electrode 2 were wound sandwiching the separator 3, and the obtained wound group was inserted in the battery can 4.

The negative electrode collecting lead pieces 6 were collected and welded to the negative electrode collecting lead portion 8 made of nickel by ultrasonic welding, and the negative electrode collecting lead portion 8 was welded to the bottom of the battery can 4 (FIG. 1). The positive electrode collecting lead pieces 5 were welded to the positive electrode collecting lead portion 7 made of aluminum by ultrasonic welding, and the positive electrode collecting lead portion 7 was welded to the battery cover 9 by resistance welding. After a liquid electrolyte (LiPF₆ was dissolved in the solvent of EC (ethylene carbonate) and MEC (methyl-ethyl carbonate), the ratio of EC and MEC being 1:2) was poured into the battery can 4, the open end of the battery can 4 was sealed with the battery cover 9 by caulking the battery can 4 to obtain a cylindrical battery.

The gasket 12 was inserted between the upper part of the battery can 4 and the cover 9 for insulation and sealing.

### Example 2

As a positive electrode active material, particles of LiCoO₂ having an average size of 15 μm were used in the same way as in Example 1. The surfaces of the particles of the positive electrode active material were covered with particles of polymethyl methacrylate having an average size of 0.5 μm by mechanofusion. The weight ratio of the positive electrode active material and the particles of polymethyl methacrylate was 100:1 in this case.

The obtained positive electrode active material covered with polymethyl methacrylate, graphite as a conductive agent, and polyvinylidene fluoride as a binder were mixed by the weight ratio of 85:10:5, and a positive electrode was produced in the same way as in Example 1.

A battery was produced in the same way as in Example 1 except the production of the positive electrode mixture.

### Example 3

In the present example, a battery was produced in the same way as in Example 1, except that LiNi_{0.33}Mn_{0.33}Co_{0.33}O₂ having an average particle size of 13 μm was used as a positive electrode active material.

### Example 4

In the present example, a battery was produced in the same way as in Example 2, except that particles of LiNi_{0.33}Mn_{0.33}Co_{0.33}O₂ were used as a positive electrode active material.

### Comparative Example 1

In the present comparative example, particles of polymethyl methacrylate were not mixed in a positive electrode active material. LiCoO₂ were used as the positive electrode active material. The positive electrode active material, graphite as a conductive agent, and polyvinylidene fluoride as a binder were mixed by the weight ratio of 85:10:5, and a positive electrode was produced in the same way as in Example 1. A battery was produced in the same way as in Example 1 by using the obtained positive electrode.

### Comparative Example 2

In the present comparative example, the surface of a positive electrode active material was covered with acetylene black used as a conductive agent by mechanofusion, and the surface of the covered positive electrode active material was further covered with polymethyl methacrylate. In this case, LiCoO₂ was used as the positive electrode active material, and the weight ratio of the positive electrode active material and acetylene black was 100:3. The surface of the obtained positive electrode active material covered with acetylene black was further covered with particles of polymethyl methacrylate having an average size of 0.5 μm. The weight ratio of the positive electrode active material covered with acetylene black and the particles of polymethyl methacrylate was 100:1 in this case.

The covered positive electrode active material thus obtained, graphite as a conductive agent, and polyvinylidene fluoride as a binder were mixed by the weight ratio of 88:7:5 to produce a positive electrode in the same way as in Example 1. A battery was produced in the same was as in Example by using the obtained positive electrode.

### (Evaluation of Performance)

Each of the batteries of Examples 1 to 4 and Comparative Examples 1 and 2 was charged and discharged with an end-of-charge voltage of 4.2V, an end-of-discharge voltage of 3.0V, and a charge-discharge rate of 1C (1 hour rate), and then the capacity of each battery was evaluated. An overcharge test was performed by overcharging each of the batteries in full charge to an SOC (State Of Charge) of 200% with a charge rate of 1C. The results of the overcharge test are shown in Table 1.

TABLE 1

| | | Surface Temperature |
|---|---|---|
| | Configuration of Positive Electrode | of Battery |
| Example 1 | mixture of LiCoO₂ and | 120° C. |
| | Polymethyl methacrylate | |
| Example 2 | LiCoO₂ covered with Polymethyl | 113° C. |
| | methacrylate | |
| Example 3 | mixture of LiNi_{0.33}Mn_{0.33}Co_{0.33} | 131° C. |
| | and Polymethyl methacrylate | |
| Example 4 | LiNi_{0.33}Mn_{0.33}Co_{0.33} covered with | 128° C. |
| | Polymethyl methacrylate | |
| Comparative | Only LiCoO₂ | 315° C. |
| example 1 | | |
| Comparative | carbon-covered LiCoO₂ covered | 302° C. |
| example 2 | with polymethyl methacrylate | |

As is clear from Table 1, the surface temperatures of the batteries were different from each other depending on the presence or absence of polymethyl methacrylate.

In Examples 1 to 4, the surface temperatures of the batteries were within a range of 110 to 130° C., the temperatures moderately rising without an unfavorable phenomenon such as ignition of the batteries. It can be considered that, when the temperature of a battery became high, the particles of polymethyl methacrylate absorbed the liquid electrolyte, thereby suppressing an exothermic reaction between the liquid electrolyte and the positive electrode. It can also be considered that the absorption of the liquid electrolyte started at approximately 100° C. As a result, a rapid increase in the temperature was not caused.

In each of the batteries according to Comparative Examples 1 and 2, the surface temperature was as high as approximately 300° C. and a smoke generation was observed. It is considered that the positive electrode active material reacted with the liquid electrolyte at high temperature, further causing a rapid increase in the temperature.

In Comparative Example 2, it can be considered that the positive electrode reacted with the liquid electrolyte and the temperature of the battery increased because the liquid electrolyte around the surfaces of the particles of the positive electrode active material was not fully absorbed in the particles of polymethyl methacrylate due to the acetylene black on the surfaces of the particles of the positive electrode active material.

What is claimed is:

1. A lithium ion secondary battery comprising:
a positive electrode for occluding and releasing lithium ions;
a negative electrode for occluding and releasing lithium ions;
a separator disposed between the positive electrode and the negative electrode; and
a non-aqueous liquid electrolyte containing a lithium salt;
wherein particles of polymethyl methacrylate exist between particles of positive electrode active material in the positive electrode, the particles of polymethyl methacrylate being in contact with surfaces of the particles of the positive electrode active material.

2. The lithium ion secondary battery according to claim 1,
wherein the particles of the positive electrode active material are mixed with the particles of polymethyl methacrylate.

3. The lithium ion secondary battery according to claim 1,
wherein each of the particles of the positive electrode active material is directly covered with the particles of polymethyl methacrylate.

4. The lithium ion secondary battery according to claim 1,
wherein the positive electrode active material includes 5 weight percent polymethyl methacrylate or less.

5. A lithium ion secondary battery comprising:
a positive electrode for occluding and releasing lithium ions;
a negative electrode for occluding and releasing lithium ions;
a separator disposed between the positive electrode and the negative electrode; and
a non-aqueous liquid electrolyte containing a lithium salt;
wherein the positive electrode includes particles of polymethyl methacrylate.
